(19) United States
(12) Patent Application Publication
(10) Pub. No.: US 2026/0154588 A1
(43) Pub. Date: Jun. 4, 2026

(54) GENERATION DEVICE AND GENERATION METHOD FOR QUBIT DRIVING SIGNALS, AND QUANTUM COMPUTER

(71) Applicant: Origin Quantum Computing Technology (Hefei) Co., Ltd., Hefei, Anhui (CN)

(72) Inventors: XUEBAI LI, Anhui (CN); Weicheng Kong, Anhui (CN)

(73) Assignee: Origin Quantum Computing Technology (Hefei) Co., Ltd., Hefei, Anhui (CN)

(21) Appl. No.: 18/705,657

(22) PCT Filed: Oct. 27, 2022
(86) PCT No.: PCT/CN2022/127938

§ 371 Date: Apr. 29, 2024

(30) Foreign Application Priority Data
Oct. 29, 2021 (CN) 202111268407.9

(51) Int. Cl. G06N 10/40; G06N 10/20

(52) U.S. Cl. CPC G06N 10/40; G06N 10/20

(57) ABSTRACT

Disclosed is a generation device for qubit driving signals, comprising: a microwave source module configured for outputting a plurality of microwave signals with different frequencies in a plurality of paths; a control module connected to the microwave source module and configured for determining a phase coherence point based on frequencies or phases of the two microwave signals in two paths and outputting a trigger signal according to the phase coherence point; a waveform outputting module configured for outputting IF signals corresponding to the qubit driving signals in a plurality of paths in response to the trigger signal; and a signal processing module connected to the microwave source module and the waveform outputting module, and configured for outputting the qubit driving signals in a plurality of paths based on the IF signals in a plurality of paths and the microwave signals in a plurality of paths.

### CROSS-REFERENCE TO RELATED APPLICATIONS

The present disclosure is a National Stage of International Application No. PCT/CN2022/127938, which claims priority to a Chinese patent application No. 202111268407.9 filed with the CNIPA on Oct. 29, 2021 and entitled “GENERATION DEVICE AND GENERATION METHOD FOR QUBIT DRIVING SIGNALS, AND QUANTUM COMPUTER”, both of which are hereby incorporated by reference in their entireties.

### TECHNICAL FIELD

The present disclosure relates to the field of quantum computation, and particularly to a generation device and a generation method for qubit driving signals, and a quantum computer.

### BACKGROUND

A quantum chip is a core component for executing quantum computing, and is integrated with multiple qubits therein. In order to guarantee normal operation of qubits, it is necessary to build a special quantum measurement and control system to provide various driving signals for each qubit, such as qubit driving signals that drive the quantum state information of the qubits, wherein the qubit driving signal is generated by mixing microwave signals with intermediate frequency (IF) signals through a mixer with a frequency mixing technique. With the development of technology, the number of qubits on quantum chips has increased to hundreds, or even tens of thousands, and the number of required qubit driving signals and the number of microwave sources have increased accordingly. Besides, due to different frequencies of qubits, the frequencies of the corresponding applied quantum state control signals are different. In the prior art, when a multi-path microwave source is used to output microwave signals with different frequencies to generate qubit driving signals with different frequencies, the phase difference between the microwave signals output by the multi-path microwave source changes from time to time, making it difficult for the phases of the multi-path qubit driving signals to be coherent.

### SUMMARY

The present disclosure is directed to provide a generation device and a generation method for qubit driving signals, and a quantum computer intended for addressing shortcomings and deficiencies in the prior art, which can ensure that phases of output multi-path qubit driving signals are coherent.

A first aspect of the present disclosure provides a generation device for qubit driving signals, and the qubit driving signals are obtained from processing of intermediate frequency (IF) signals and microwave signals; the generation device comprises: a microwave source module configured for outputting a plurality of microwave signals with different frequencies in a plurality of paths, wherein frequencies of the microwave signals correspond to frequencies of the qubit driving signals; a control module connected to the microwave source module and configured for determining a phase coherence point based on frequencies or phases of the two microwave signals in two paths and outputting a trigger signal according to the phase coherence point, wherein the phase coherence point is a time point when phase differences of the two microwave signals in the two paths are equal; a waveform outputting module connected to the control module and configured for outputting IF signals corresponding to the qubit driving signals in a plurality of paths in response to the trigger signal; and a signal processing module connected to the microwave source module and the waveform outputting module, and configured for outputting the qubit driving signals in a plurality of paths based on the IF signals in a plurality of paths and the microwave signals in a plurality of paths.

In the device as described above, the microwave source module comprises a first microwave source and a second microwave source, wherein a frequency of a first microwave signal output by the first microwave source is lower than that of a second microwave signal output by the second microwave source.

In the device as described above, when the control module is configured for determining a phase coherence point based on frequencies of the two microwave signals in two paths and outputting a trigger signal according to the phase coherence point, the control module comprises: a frequency difference determining unit configured for determining a frequency difference between the two microwave signals in two paths; a trigger cycle determining unit configured for determining a reciprocal of the frequency difference as a trigger cycle of the phase coherence point; and a first trigger unit configured for outputting the trigger signal based on the trigger cycle.

In the device as described above, the first microwave signal and the second microwave signal correspond to different qubit driving signals, respectively, and the frequency difference determining unit is configured for: determining a frequency difference between the first microwave signal and the second microwave signal.

In the device as described above, the first microwave signal and the second microwave signal correspond to the same qubit driving signal, and the frequency difference determining unit is configured for: determining a frequency difference between the two first microwave signals in two paths, wherein the two first microwave signals in two paths correspond to qubit driving signals with different frequencies respectively.

In the device as described above, the second microwave source is configured for outputting second microwave signals in two paths based on the frequency difference between the two first microwave signals in two paths, wherein a frequency difference between the two second microwave signals in two paths is an integer multiple of the frequency difference between the two first microwave signals in two paths.

In the device as described above, the first trigger unit is configured for outputting the trigger signal at an integer multiple of the trigger cycle.

In the device as described above, when the control module is configured for determining a phase coherence point based on phases of the two microwave signals in two paths and outputting a trigger signal according to the phase coherence point, the control module comprises: a first phase difference determining unit configured for determining, as a preset phase difference, a phase difference between the first microwave signal and the second microwave signal at the same time point; a first phase measuring unit configured for obtaining a current phase difference between the first microwave signal and the second microwave signal; a second trigger unit configured for determining a time point when the current phase difference equals to the preset phase difference as the phase coherence point and outputting the trigger signal at the phase coherence point.

In the device as described above, when the control module is configured for determining a phase coherence point based on phases of the two microwave signals in two paths and outputting a trigger signal according to the phase coherence point, the control module comprises: a second phase difference determining unit configured for determining, as a preset phase difference, a difference between a first phase difference between the two first microwave signals in two paths and a second phase difference between the two second microwave signals in two paths; a second phase measuring unit configured for obtaining a current first phase difference between the two first microwave signals in two paths, and a current second phase difference between the two second microwave signals in two paths; a third trigger unit configured for determining a time point when a difference between the current first phase difference and the current second phase difference equals to the preset phase difference as the phase coherence point, and outputting the trigger signal at the phase coherence point.

In the device as described above, the waveform outputting module comprises at least two waveform generators, each of which is configured for outputting at least one of the IF signals in response to the trigger signal.

In the device as described above, the control module simultaneously sends the trigger signal to each of the waveform generators.

In the device as described above, the signal processing module comprises at least two frequency mixing units, each of which is configured for: outputting the qubit driving signal in one path based on the IF signals in two paths and the first microwave signal in one path; or outputting the qubit driving signal in one path based on the IF signals in two paths and the second microwave signal in one path.

In the device as described above, the signal processing module comprises at least two frequency mixing units, each of which is configured for outputting the qubit driving signal in one path based on the IF signal in one path, the first microwave signal in one path and the second microwave signal in one path.

Another aspect of the present disclosure provides a generation method for qubit driving signals, the qubit driving signals are configured for adjusting quantum state information of qubits on a quantum chip and are obtained from processing of IF signals and microwave signals; the method comprises:
obtaining a plurality of microwave signals with different frequencies in a plurality of paths, wherein frequencies of the microwave signals correspond to frequencies of the qubit driving signals; determining a phase coherence point based on frequencies or phases of the two microwave signals in two paths and outputting a trigger signal according to the phase coherence point, wherein the phase coherence point is a time point when phase differences of the two microwave signals in the two paths are equal; generating IF signals corresponding to the qubit driving signals in a plurality of paths in response to the trigger signal; and outputting the qubit driving signals in a plurality of paths based on the IF signals in a plurality of paths and the microwave signals in a plurality of paths.

In the method as described above, said “obtaining a plurality of microwave signals with different frequencies in a plurality of paths” comprises: obtaining first a plurality of microwave signals with different frequencies in a plurality of paths and second a plurality of microwave signals with different frequencies in a plurality of paths, wherein a frequency of the first microwave signals is lower than that of the second microwave signals.

In the method as described above, said “determining a phase coherence point based on frequencies or phases of the two microwave signals in two paths and outputting a trigger signal according to the phase coherence point” comprises: determining a frequency difference between the two microwave signals in two paths; determining a reciprocal of the frequency difference as a trigger cycle of the phase coherence point; generating the trigger signal based on the trigger cycle.

In the method as described above, when the first microwave signals and the second microwave signals correspond to different qubit driving signals, respectively, said “determining a frequency difference between the two microwave signals in two paths” comprises: determining a frequency difference between the first microwave signals and the second microwave signals.

In the method as described above, when the first microwave signals and the second microwave signals correspond to the same qubit driving signal, said “determining a frequency difference between the two microwave signals in two paths” comprises: determining a frequency difference between the two first microwave signals in two paths, wherein the two first microwave signals in two paths correspond to the qubit driving signals with different frequencies respectively.

In the method as described above, when the first microwave signals and the second microwave signals correspond to the same qubit driving signal, said “determining a frequency difference between the two microwave signals in two paths” further comprises: determining two second microwave signals in two paths based on the frequency difference between the two first microwave signals in two paths, wherein a frequency difference between the two second microwave signals in two paths is an integer multiple of the frequency difference between the two first microwave signals in two paths.

In the method as described above, said “generating the trigger signal based on the trigger cycle” comprises: generating the trigger signal at an integer multiple of the trigger cycle.

In the method as described above, said “determining a phase coherence point based on phases of the two microwave signals in two paths and generating a trigger signal according to the phase coherence point” comprises: determining, as a preset phase difference, a phase difference between the first microwave signal and the second microwave signal at the same time point; obtaining a current phase difference between the first microwave signal and the second microwave signal; determining a time point when the current phase difference equals to the preset phase difference as the phase coherence point and outputting the trigger signal at the phase coherence point.

In the method as described above, said “determining a phase coherence point based on phases of the two microwave signals in two paths and generating a trigger signal according to the phase coherence point” comprises: determining, as a preset phase difference, a difference between a first phase difference between the two first microwave signals in two paths, and a second phase difference between the two second microwave signals in two paths; obtaining a current first phase difference between the two first microwave signals in two paths, and a current second phase difference between the two second microwave signals in two paths; determining a time point when a difference between the current first phase difference and the current second phase difference equals to the preset phase difference as the phase coherence point, and outputting the trigger signal at the phase coherence point.

Yet another aspect of the present disclosure provides a quantum computer, comprising the generation device for qubit driving signals described above, or using the generation method for qubit driving signals described above to generate qubit driving signals for adjusting quantum state information of qubits on a quantum chip.

Compared to prior art, the qubit driving signals that need to be generated for the present disclosure are obtained from processing of IF signals and microwave signals; by means of the microwave source module, outputting a plurality of microwave signals with different frequencies in a plurality of paths, wherein frequencies of the microwave signals correspond to frequencies of the qubit driving signals; and by means of the control module, connecting the microwave source module and determining a phase coherence point based on frequencies or phases of the two microwave signals in two paths and outputting a trigger signal according to the phase coherence point, wherein the phase coherence point is a time point when phase differences of the two microwave signals in the two paths are equal; and then by means of the waveform outputting module, in response to the trigger signal, outputting IF signals corresponding to the qubit driving signals in a plurality of paths; since the phase differences of the two microwave signals in the two paths are equal, phases of the qubit driving signals in a plurality of paths output by the signal processing module based on the IF signals in a plurality of paths and the microwave signals in a plurality of paths are coherent.

### BRIEF DESCRIPTION OF THE DRAWINGS

FIG. 1 is a structural diagram of a generation device for qubit driving signals according to an embodiment of the present disclosure;

FIG. 2 is a structural diagram of a microwave source module according to an embodiment of the present disclosure;

FIG. 3 is a structural diagram of a control module according to an embodiment of the present disclosure;

FIG. 4 is a structural diagram of another control module according to an embodiment of the present disclosure;

FIG. 5 is a structural diagram of another control module according to an embodiment of the present disclosure;

FIG. 6 is a flowchart of a generation method for qubit driving signals according to an embodiment of the present disclosure;

FIG. 7 is a flowchart of a frequency generation trigger signal based on the microwave signals in a plurality of paths according to an embodiment of the present disclosure;

FIG. 8 is a flowchart of a phase generation trigger signal based on the microwave signals in a plurality of paths according to an embodiment of the present disclosure;

FIG. 9 is a flowchart of another phase generation trigger signal based on the microwave signals in a plurality of paths according to an embodiment of the present disclosure.

### DESCRIPTION OF REFERENCE SIGNS

1—microwave source module, 2—control module, 3—waveform outputting module, 4—signal processing module, 11—first microwave source, 12—second microwave source, 201—frequency difference determining unit, 202—trigger cycle determining unit, 203—first trigger unit, 211—first phase difference determining unit, 212—first phase measuring unit, 213—second trigger unit, 221—second phase difference determining unit, 222—second phase measuring unit, 223—third trigger unit.

### DETAILED DESCRIPTION

The embodiments described below with reference to the drawings are exemplary and are intended only to explain the present application and are not to be construed as limiting the present application.

The operating frequency of the quantum chip is relatively high, usually set at about 6 GHZ, and the frequency of qubit driving signals for driving qubits on the quantum chip is correspondingly about 6 GHz. The frequency of the driving signal for driving the qubit is in one-to-one correspondence with the working frequency of the qubit, so that the driving effect on the qubit is optimal.

Wherein, the IF signals that carry the modulation-encoded information for driving the qubits have a relatively low frequency and are unable to drive the qubits. Therefore, it is necessary to process the IF signals through frequency mixing to obtain high-frequency signals that can drive the qubits. Specifically, it is necessary to obtain the required qubit driving signals by mixing IF signals with microwave signals.

The operating frequencies of the various qubits on the quantum chip can be the same or different; when the operating frequencies of the various qubits are different, the frequencies of the qubit driving signals will also be different. When the frequencies of the qubit driving signals to be generated are different, the frequencies of the corresponding microwave signals are also different. There is a phase difference between the microwave signals at different frequencies, and the phase difference varies over time, which results in phase incoherence between the microwave signals and in turn results in phase incoherence between the generated qubit driving signals in a plurality of paths.

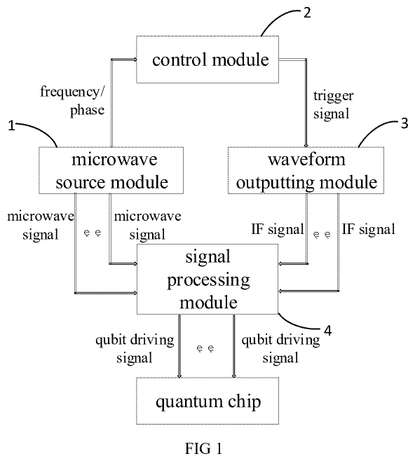

As shown in FIG. 1, an embodiment of the present disclosure provides a generation device for qubit driving signals, the qubit driving signals are obtained from processing of intermediate frequency (IF) signals and microwave signals; the generation device comprising: a microwave source module configured for outputting a plurality of microwave signals with different frequencies in a plurality of paths; wherein frequencies of the microwave signals correspond to frequencies of the qubit driving signals; a control module connected to the microwave source module and configured for determining a phase coherence point based on frequencies or phases of the two microwave signals in two paths and outputting a trigger signal according to the phase coherence point; wherein the phase coherence point is a time point when phase differences of the two microwave signals in the two paths are equal; a waveform outputting module connected to the control module and configured for outputting IF signals corresponding to the qubit driving signals in a plurality of paths in response to the trigger signal; a signal processing module connected to the microwave source module and the waveform outputting module, and configured for outputting the qubit driving signals in a plurality of paths based on the IF signals in a plurality of paths and the microwave signals in a plurality of paths. It should be noted that the IF signals carry information that is used to drive the quantum state of the qubit to change a preset target. For example, the preset target of the change of the quantum state of the qubit can be represented by a quantum logic gate or a sequence of quantum logic gates.

The present disclosure outputs a plurality of microwave signals with different frequencies in a plurality of paths through the microwave source module 1; then connects the microwave source module 1 through the control module 2 so as to obtains the frequency or phase parameters of a plurality of microwave signals with different frequencies in a plurality of paths, and determines one phase coherence point where the phase differences of the microwave signals in a plurality of paths are consistent through the frequency or phase parameters, wherein the phase coherence point can be understood that the phase difference of microwave the signals in a plurality of paths at a certain time point is the same as an initial phase difference, that is, at this time, the phases of the microwave signals in a plurality of paths are coherent; and outputs the trigger signal to the waveform outputting module 3 at this point. When the waveform outputting module 3 receives the trigger signal, the IF signals in a plurality of paths is output to the signal processing module 4, and the signal processing module 4 performs mixing processing based on the currently received IF signals in a plurality of paths and the microwave signals in a plurality of paths. Since the phases of the current microwave signals in a plurality of paths are coherent, the phases between the qubit driving signals in a plurality of paths output by signal processing module 4 are also coherent. Wherein, the control module 2 of the present disclosure may employ a FPGA (Field-Programmable Gate Array), i.e., a field programmable gate array.

In addition, since the first microwave signals in a plurality of paths are periodic signals, the corresponding phase coherence points are also periodic. After the control module 2 obtains the phase coherence point of the microwave signals in a plurality of paths, repeatedly outputting the trigger signal to the waveform outputting module 3 according to the cycle of the phase coherence point, thereby ensuring that the phases between the qubit driving signals in a plurality of paths output by the signal processing module 4 each time are coherent. It is well known that the quantum state information of a qubit is a probability distribution, and the driving of the qubit needs to be repeated many times. Therefore, the generation device for qubit driving signals of the present disclosure may also improve the calculation accuracy of the quantum chip.

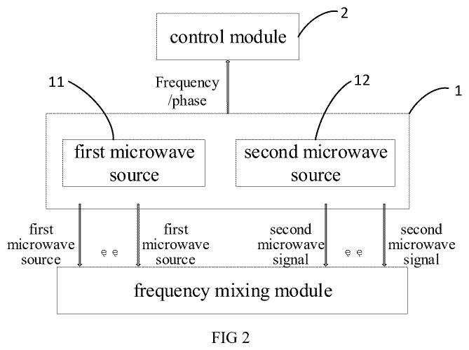

As shown in FIG. 2, as an implementation of an embodiment of the present disclosure, the microwave source module comprises a first microwave source 11 and a second microwave source 12, wherein a frequency of a first microwave signal output by the first microwave source 11 is lower than that of a second microwave signal output by the second microwave source 12.

When the working frequencies of various qubits on the quantum chip are different, and after greatly increasing the qubits, the working bandwidth of the quantum chip and the bandwidth of the qubit driving signals are caused to be increased, for example, the operating frequency of the quantum chip is 4-6 GHz, and the operating bandwidth has reached 2 GHz. As technology progresses, wider bandwidths may be achieved later. By providing microwave signals in different frequency bands through the first microwave source 11 and the second microwave source 12, and by expanding the number of the first microwave source 11 and the second microwave source 12, the bandwidth of microwave signals used for mixing frequencies is wider, which enables the generation of qubit driving signals with a wider bandwidth, thereby facilitating the expansion of the qubits on the quantum chip.

Since the first microwave source 11 and the second microwave source 12 are adopted and the plurality of microwave signals output by the first microwave source 11 and the second microwave source 12 have different frequencies, that is, the phase differences of the plurality of microwave signals are different such that the phases of the generated qubit driving signals in a plurality of paths are incoherent, it is necessary to use the control module to determine the phase coherence point based on the frequencies or phases of the multiple microwave signals, and output the trigger signal based on the cycle of the phase coherence point, so as to ensure that the phases of the qubit driving signals in a plurality of paths generated by the signal processing module are also coherent.

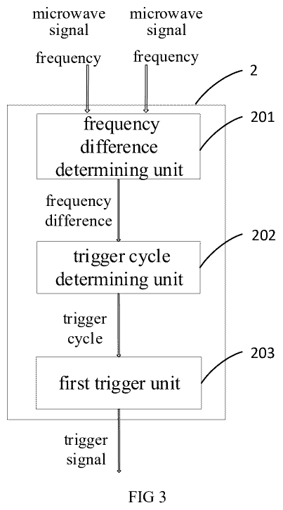

As shown in FIG. 3, as one implementation, when the control module is configured for determining a phase coherence point based on frequencies of the two microwave signals in two paths and outputting a trigger signal according to the phase coherence point, the control module 2 comprises: a frequency difference determining unit 201 configured for determining a frequency difference between the two microwave signals in two paths; a trigger cycle determining unit 202 configured for determining a reciprocal of the frequency difference as a trigger cycle of the phase coherence point; a first trigger unit 203 configured for outputting the trigger signal based on the trigger cycle.

The frequencies of the two microwave signals in two paths outputted by the microwave source module 1 are 5.0 GHz and 5.2 GHz, wherein the initial phases of the two microwave signals in two paths can be the same or different; the present embodiment employs an example where at an initial time point the phases of the two microwave signals in the two paths are the same; the frequency difference determining unit 201 determines the frequency difference between the two microwave signals in two paths as 200 MHz, and the trigger cycle determining unit 202 determines the reciprocal of the frequency difference as the trigger cycle of the phase coherence point, i.e., the reciprocal of 200 MHz is 0.5 ns; wherein the phase coherence point means that every 0.5 ns, the current phase difference of the two microwave signals in two paths is the same as the initial phase difference, i.e., the current phase of the two microwave signals in two paths is also coherent; finally, the first trigger unit 203 outputs the trigger signal to the waveform output module 3 based on the trigger cycle of the phase coherence point at 0.5 ns, and the waveform output module 3 outputs the IF signals to the signal processing module 4 in response to the trigger signal, ensuring that the phases of the qubit driving signals in two paths generated by signal processing module 4 are also coherent.

It should be added that when qubit driving signals are generated by mixing the microwave signals and the IF signals, the IQ frequency mixing technique or the secondary frequency conversion technology may be used. When the IQ frequency mixing technique is used, both the first microwave signal output by the first microwave source 1 and the second microwave signal output by the second microwave source 12 may be used as local oscillator signals; when the secondary frequency conversion technology is used, the first microwave signal is used as the local oscillator signal during the first frequency conversion, and the second microwave signal is used as the local oscillator signal during the second frequency conversion.

When the IQ frequency mixing technique is used to generate the qubit driving signals, the first microwave signal and the second microwave signal correspond to different qubit driving signals, respectively, and the frequency difference determining unit 201 is configured for: determining a frequency difference between the first microwave signal and the second microwave signal. Specifically, since the frequencies of the first microwave signal and the second microwave signal are different, the phases of the generated a plurality of microwave signals with different frequencies in a plurality of paths are incoherent. By determining the frequency difference between the first microwave signal and the second microwave signal through the frequency difference determining unit 201, determining the reciprocal of the frequency difference between the first microwave signal and the second microwave signal as the trigger cycle of the phase coherence point through the trigger cycle determining unit 202, and then outputting the trigger signal to the signal processing module through the first trigger unit 203 at the trigger cycle time of the phase coherence point of the first microwave signal and the second microwave signal, since the phases of the first microwave signal and the second microwave signal at this time are coherent, the phases of the qubit driving signals in a plurality of paths obtained by performing frequency mixing with the signal processing module 4 are also coherent.

When the secondary frequency conversion technology is used to generate the qubit driving signals, the first microwave signal and the second microwave signal correspond to the same qubit driving signal, and the frequency difference determining unit 201 is configured for: determining a frequency difference between the two first microwave signals in two paths, wherein the two first microwave signals in two paths correspond to qubit driving signals with different frequencies respectively.

Specifically, when the secondary frequency conversion technology is used to generate the qubit driving signals with different frequencies in a plurality of paths, since the frequencies of a plurality of first micro-signals are different and the frequencies of a plurality of second micro-signals are also different, the phases of the first micro-signals with different frequencies in a plurality of paths are incoherent, and the phase of second micro-signals with different frequencies in a plurality of paths is also incoherent, which causes the phases of the generated plurality of microwave signals with different frequencies in a plurality of paths to be incoherent. By determining the frequency difference between the first microwave signals with different frequencies in two paths through the frequency difference determining unit 201, determining the reciprocal of the frequency difference between the two first microwave signals in two paths as the trigger cycle of the phase coherence point through the trigger cycle determining unit 202, and at this time outputting the trigger signal to the signal processing module 4 through the first trigger unit 203, since the phases of the two first microwave signals in two paths at this time are coherent, the phases between the IF signals in a plurality of paths to be processed by the secondary frequency conversion and outputted by the signal processing module 4 through the first frequency conversion processing are coherent.

When the signal processing module performs the second frequency conversion processing, the second microwave source 12 outputs the two second microwave signals in two paths based on the frequency difference between the two first microwave signals in two paths; wherein a frequency difference between the two second microwave signals in two paths is an integer multiple of the frequency difference between the two first microwave signals in two paths.

Specifically, since the phase coherence point of the first microwave signals with different frequencies in two paths is determined by the frequency difference between the two first microwave signals in two paths, when the frequency difference between the two second microwave signals in two paths outputted by the second microwave source 12 is set to an integer multiple of the frequency difference between the two first microwave signals in two paths, since the trigger cycle of the phase coherence point is obtained by the derivative of the frequency difference, it can be understood that the trigger cycle of the phase coherence point of the two first microwave signals in two paths is an integer multiple of the cycle of the phase coherence point of the two second microwave signals in two paths. That is, when the phase coherence point of the two first microwave signals in two paths is used, the two second microwave signals in two paths at this time must also be at the phase coherence point, so as to ensure that when the first trigger unit 203 outputs the trigger signal based on the cycle of the phase coherence point of the two first microwave signals in two paths, the phases of the first micro wave signals in two paths and the two second microwave signals in two paths are both coherent so that the phase of the qubit driving signals in a plurality of paths generated by the second frequency conversion through the signal processing module 4 are also coherent.

Specifically, the first trigger unit 203 is configured for outputting the trigger signal at an integer multiple of the trigger cycle. By achieving coherence of the current phases of the microwave signals in a plurality of paths by a trigger cycle, the first trigger unit 203 can, at the integral multiple time of the trigger cycle, for example, 1 times, 2 times, and 3 times of the trigger cycle, and taking the trigger cycle of 0.5 ns in the above example as an example, the first trigger unit 203 can, at 0.5 ns or 1 ns or 5 ns, ensure the coherence of the current phases of the microwave signals in a plurality of paths by outputting the trigger signal, thereby enabling flexibility in triggering.

As mentioned above, when the IQ frequency mixing technique is used to generate the qubit driving signals, it is not only possible to determine the phase coherence point using the frequency difference between the first microwave signal and the second microwave signal and output the trigger signal based on the phase coherence point to enable the signal processing module 4 to generate a plurality of qubit driving signals with coherent phases in a plurality paths, but also possible to use the phase difference between the first microwave signal and the second microwave signal to enable phase coherence of the plurality of qubit driving signals in a plurality paths generated by the signal processing module 4. The specific implementation method therefor is described as follows.

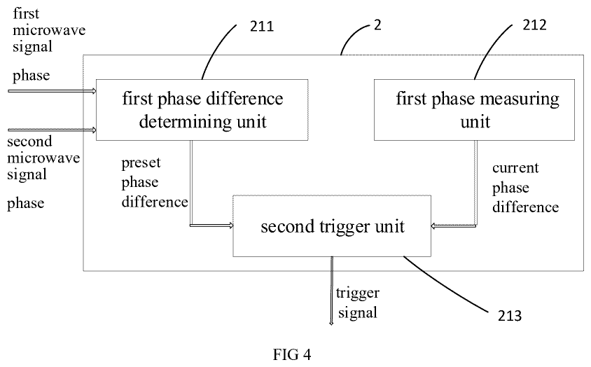

As shown in FIG. 4, as another implementation, when the control module 2 determines the phase coherence point based on the phases of the two microwave signals in two paths and outputs the trigger signal according to the phase coherence point, the control module 2 comprises: a first phase difference determining unit 211 configured for determining, as a preset phase difference, a phase difference between the first microwave signal and the second microwave signal at the same time point; a first phase measuring unit 212 configured for obtaining a current phase difference between the first microwave signal and the second microwave signal; a second trigger unit 213 configured for determining a time point when the current phase difference equals to the preset phase difference as the phase coherence point and outputting the trigger signal at the phase coherence point.

Exemplarily, the frequency of the first microwave signal output by the first microwave source 11 is 5.0 GHz, and the frequency of the second microwave signal output by the second microwave source 12 is 5.2 GHz, wherein initial phases of the first micro wave signal and the second microwave signal may be the same or different, which is achieved by setting the output parameters of the first microwave source 11 and the second microwave source 12. The same initial phase is used in the practice of the present disclosure. By determining the phase difference of 90 degrees between the first microwave signal and the second microwave signal at the same time point through the first phase difference determining unit 211 as the preset phase difference; and by measuring the current phase difference between the first microwave signal and the second microwave signal in real time through the first phase measuring unit 212; by using a preset phase difference as a reference and comparing the current phase difference with the preset phase difference through the second trigger unit 213, it is possible to determine the time point when the current phase difference is the same as the preset phase difference as the phase coherence point and output the trigger signal at the moment. Since the phase difference between the first microwave signal and the second microwave signal input to the signal processing module 4 at the current time point is consistent, that is, coherent, it is possible to ensure that the phases of the qubit driving signals in two paths generated by the signal processing module 4 are coherent.

As described above, when the secondary frequency conversion technology is used to generate the qubit driving signals in a plurality of paths, it is not only possible to use the frequency difference between the two first microwave signals in two paths and the frequency difference between the two second microwave signals in two paths to enable phase coherence of the plurality of qubit driving signals in a plurality paths generated by the signal processing module 4, but also use the phase difference between the first microwave signal in a plurality of paths and the second microwave signal in a plurality of paths to enable phase coherence of the plurality of qubit driving signals in a plurality paths generated by the signal processing module 4, and the specific implementation method is described as follows.

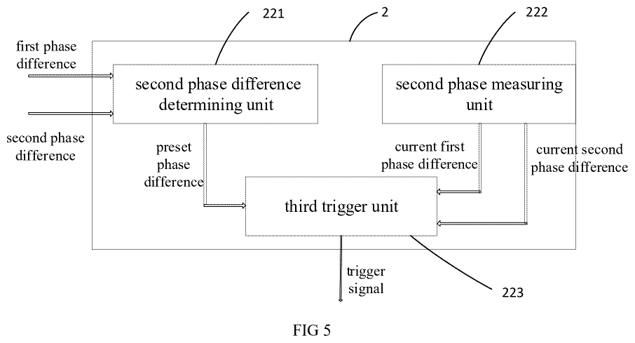

As shown in FIG. 5, as another implementation, when the control module 2 determines the phase coherence point based on the phases of the two microwave signals in two paths and outputs the trigger signal according to the phase coherence point, the control module 2 comprises: a second phase difference determining unit 221 configured for determining, as a preset phase difference, a difference between a first phase difference between the two first microwave signals in two paths and a second phase difference between the two second microwave signals in two paths; a second phase measuring unit 222 configured for obtaining a current first phase difference between the two first microwave signals in two paths, and a current second phase difference between the two second microwave signals in two paths; and a third trigger unit 223 configured for determining a time point when a difference between the current first phase difference and the current second phase difference equals to the preset phase difference as the phase coherence point, and outputting the trigger signal at the phase coherence point.

Specifically, there is a phase difference not only between the two first microwave signals in two paths but also between the two second microwave signals in two paths. First, the second phase difference determining unit 221 determines the first phase difference between the two first microwave signals in two paths and the second phase difference between the two second microwave signals in two paths at a certain moment, and determines a difference value between the first phase difference and the second phase difference as a fixed value and takes this fixed value as the preset phase difference, wherein the fixed value may be 0 or other values; then, the second phase measuring unit 222 measures a current first phase difference between the first microwave signals and a current second phase difference between the two second microwave signals in two paths in real time, and sends the current first phase difference and the current second phase difference to the third trigger unit 223; the third trigger unit 223 determines the difference value between the current first phase difference and the current second phase difference through calculation, compares the difference value with the preset phase difference, and determines the time point when the difference value is the same as the preset phase difference as a phase coherence point. At this moment, both the phases between the two first microwave signals in two paths and the phases between the two second microwave signals in two paths are coherent, and the trigger signal is outputted at the phase coherence point, thereby ensuring that the signal processing module 4 generates the qubit driving signals with coherent phases in a plurality of paths.

Wherein the first phase measuring unit 212 and the second phase measuring unit 222 may adopt a phase discriminator. The phase discriminator has the advantages of high sensitivity, stable performance, etc., so as to ensure the accuracy and small error of the measured current phase value, which in turn guarantees the accuracy of the trigger signal and improves the coherence accuracy of the qubit driving signals in a plurality of paths generated through the signal processing module 4.

As one implementation of an embodiment of the present disclosure, the waveform outputting module 3 comprises at least two waveform generators, each of which is configured for outputting at least one IF signal in response to the trigger signal. It can be understood that each qubit driving signal corresponds to several microwave signals and several IF signals. A plurality of waveform generators are adopted, and each waveform generator may output several IF signals in response to the trigger signal, which is configured for the signal processing module 4 to generate the qubit driving signals in more paths so as to adapt to the driving requirements of the quantum chips with more bits.

When the control module 2 of the present disclosure sends the trigger signal to the plurality of waveform generators, the control module 2 simultaneously sends the trigger signal to each of the waveform generators. By simultaneously sending the trigger signal, it is possible to ensure that the IF signals output from each waveform generator to the signal processing module 4 are synchronized and the phases between a plurality of microwave signals output from the microwave source module 1 to the signal processing module 4 are coherent, and guarantee that the phases of the qubit driving signals in a plurality of paths output from the signal processing module 4 are all coherent.

As one implementation of an embodiment of the present disclosure, the signal processing module 4 comprises at least two frequency mixing units, each of which is configured for: outputting the qubit driving signal in one path based on the IF signals in two paths and the first microwave signal in one path; or outputting the qubit driving signal in one path based on the IF signals in two paths and the second microwave signal in one path.

Specifically, when the IQ frequency mixing technique is used to generate the qubit driving signals, the first microwave source 11 outputs the first microwave signal in a plurality of paths, and the second microwave source 12 each outputs the second microwave signal in a plurality of paths. Each frequency mixing unit is configured for perform the frequency mixing on the first microwave signal in one path and the IF signals in two paths, or the second microwave signal in one path and the IF signals in two paths, thereby adapting to the driving requirements of the quantum chips with a plurality of bits.

In addition, when the secondary frequency conversion technology is used to generate the qubit driving signals, the signal processing module 4 comprises at least two frequency mixing units, each of which is configured for outputting the qubit driving signal in one path based on the IF signal in one path, the first microwave signal in one path and the second microwave signal in one path.

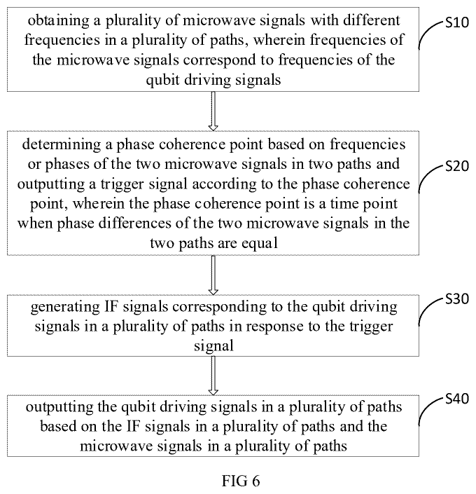

As shown in FIG. 6, an embodiment of the present disclosure further provides a generation method for qubit driving signals, the qubit driving signals are configured for adjusting quantum state information of qubits on a quantum chip and are obtained from processing of IF signals (IF) signals and microwave signals; the method comprises the following steps:
Step S10: obtaining a plurality of microwave signals with different frequencies in a plurality of paths, wherein frequencies of the microwave signals correspond to frequencies of the qubit driving signals.
Step S20: determining a phase coherence point based on frequencies or phases of the two microwave signals in two paths and outputting a trigger signal according to the phase coherence point, wherein the phase coherence point is a time point when phase differences of the two microwave signals in the two paths are equal.
Step S30: generating IF signals corresponding to the qubit driving signals in a plurality of paths in response to the trigger signal.
Step S40: outputting the qubit driving signals in a plurality of paths based on the IF signals in a plurality of paths and the microwave signals in a plurality of paths.

Specifically, the qubit driving signals in each path need to be obtained by mixing several microwave signals and several IF signals. Since the qubits on the quantum chip work at different frequencies, the corresponding qubit driving signals have different frequencies, so the frequencies of the microwave signals corresponding to each qubit driving signals will also be different.

For the qubit driving signals with different frequencies in two paths, when generating the qubit driving signals, the corresponding the plurality of microwave signals with different frequencies in a plurality of paths are determined first; then one phase coherence point of the microwave signals in a plurality of paths is determined according to the frequency or phase of the microwave signals in a plurality of paths, and the trigger signal is generated at the phase coherence point, wherein the phase coherence point may be understood that the phase difference of the microwave signals in a plurality of paths at a certain time point is the same as the initial phase difference, that is, the microwave signals in a plurality of paths are coherent at this time; then the IF signals corresponding to the qubit driving signals in two paths are generated according to the trigger signal, and are mixed with the microwave signals in a plurality of paths respectively. Since the phases of the current first microwave signal and the second microwave signal are coherent, the phases of the qubit driving signals generated by frequency mixing are also coherent.

Specifically, said “obtaining a plurality of microwave signals with different frequencies in a plurality of paths” comprises: obtaining first a plurality of microwave signals with different frequencies in a plurality of paths and second a plurality of microwave signals with different frequencies in a plurality of paths, wherein a frequency of the first microwave signals is lower than that of the second microwave signals. By adopting the first microwave signal and the second microwave signal with different frequency bands so that the bandwidth of the microwave signal used for mixing is wider, it is possible to generate qubit driving signals with wider bandwidth and thus is conducive to the expansion of qubits on quantum chips.

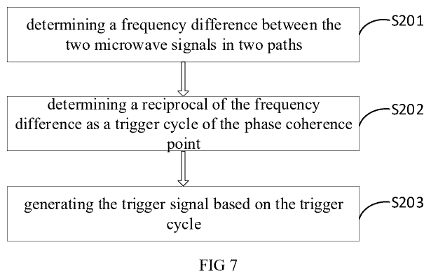

As shown in FIG. 7, as one implementation of an embodiment of the present disclosure, said “determining a phase coherence point based on frequencies or phases of the two microwave signals in two paths and outputting a trigger signal according to the phase coherence point” comprises:
Step S201: determining a frequency difference between the two microwave signals in two paths.
Step S202: determining a reciprocal of the frequency difference as a trigger cycle of the phase coherence point.
Step S203: generating the trigger signal based on the trigger cycle.

Specifically, according to the frequency parameters of qubit driving signals in two paths needed to be generated, the frequencies of the corresponding microwave signals in two paths and the corresponding frequency difference are determined; wherein the initial phases of the microwave signals in a plurality of paths may be the same or different. Taking the same initial phase of the microwave signals in a plurality of paths as an example, the phases of the microwave signals in a plurality of paths at the initial time point are coherent; the trigger cycle of the phase coherence point is obtained by calculating the reciprocal of the frequency difference, and every one trigger cycle, the current phase difference of the microwave signals in a plurality of paths will be the same as the initial phase difference, that is, the phases of the microwave signals in a plurality of paths at the current time point are coherent. At this time, the trigger signal is generated and the IF signals for frequency mixing is output through the trigger signal, so as to guarantee that the phases of the qubit driving signals in two paths generated through frequency mixing are also coherent.

When the IQ frequency mixing technique generates the qubit driving signals, and the first microwave signal and the second microwave signal correspond to different qubit driving signals, respectively, and said “determining a frequency difference between the two microwave signals in two paths” comprises: determining a frequency difference between the first microwave signal and the second microwave signal.

Specifically, the frequency difference between the first microwave signal and the second microwave signal is determined first and the reciprocal of the frequency difference between the first microwave signal and the second microwave signal is determined to be the trigger cycle of the phase coherence point, and in turn the trigger cycle is output at trigger cycle of the phase coherence point of the first microwave signal and the second microwave signal. Since the phases of the first microwave signal and the second microwave signal at this time are coherent, the phases of the generated qubit driving signals in two paths are also coherent.

When the secondary frequency conversion technology generates the qubit driving signals, the first microwave signal and the second microwave signal correspond to the same qubit driving signal, and said “determining a frequency difference between the two microwave signals in two paths” comprises: determining a frequency difference between the two first microwave signals in two paths, wherein the two first microwave signals in two paths correspond to qubit driving signals with different frequencies respectively.

Specifically, the frequency difference of the first microwave signal with different frequencies in two paths are determined, the reciprocal of the frequency difference between the two first microwave signals in two paths is determined to be the trigger cycle of the phase coherence point, and the trigger signal is output at this time. Since the phases of the two first microwave signals in two paths are coherent at this time, the phases between the IF signals in a plurality of paths to be processed by the secondary frequency conversion and outputted through the first frequency conversion processing are coherent.

When performing the second frequency conversion processing, determining frequency difference between the two microwave signals in two paths further comprises:
determining two second microwave signals in two paths based on the frequency difference between the two first microwave signals in two paths, wherein a frequency difference between the two second microwave signals in two paths is an integer multiple of the frequency difference between the two first microwave signals in two paths.

Specifically, when the frequency difference between the two second microwave signals in two paths is set as integer multiples of the frequency difference between the two first microwave signals in two paths, since the trigger cycle of the phase coherence point is obtained by the derivative of the frequency difference, it can be understood that the trigger cycle of the phase coherence point of the two first microwave signals in two paths is the integer multiples of the cycle of the phase coherence point of the two second microwave signals in two paths. That is, when the phase coherence point of the two first microwave signals in two paths is adopted, the two second microwave signals in two paths at this time must also be at the phase coherence point, so as to guarantee that when outputting the trigger signal based on the cycle of the phase coherence point of the two first microwave signals in two paths, the phases of the two first microwave signals in two paths and the two second microwave signals in two paths are coherent, such that the phases of the generated qubit driving signals in a plurality of paths are also coherent.

As one implementation of an embodiment of the present disclosure, said “generating the trigger signal based on the trigger cycle” comprises: generating the trigger signal at an integer multiple of the trigger cycle. Specifically, by achieving coherence of the current phases of the microwave signals in a plurality of paths with the trigger cycle, and thus by outputting the trigger signal at an integer multiple of the trigger cycle, such as the time points at 1 time, at 2 times, and at 3 times of the trigger cycle, it is also possible to guarantee the coherence of the current phases of the microwave signals in a plurality of paths and achieve flexibility of triggering.

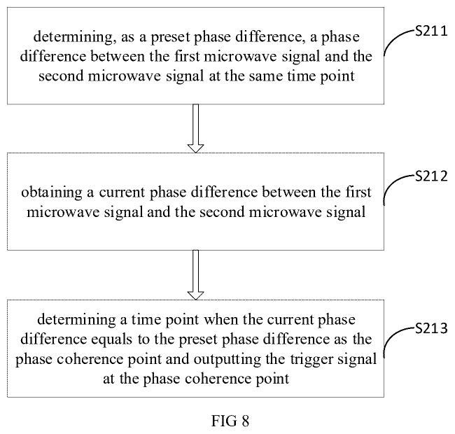

As shown in FIG. 8, as one implementation of an embodiment of the present disclosure, when the IQ frequency mixing technique is adopted to generate the qubit driving signals, said “determining a phase coherence point based on phases of the two microwave signals in two paths and generating a trigger signal according to the phase coherence point” comprises the following steps:
step S211: determining, as a preset phase difference, a phase difference between the first microwave signal and the second microwave signal at the same time point;
step S212: obtaining a current phase difference between the first microwave signal and the second microwave signal;
step S213: determining a time point when the current phase difference equals to the preset phase difference as the phase coherence point and outputting the trigger signal at the phase coherence point.

Specifically, by determining, as the preset phase difference, the phase difference between the first microwave signal and the second microwave signal at the same time point; and obtaining the current phase difference between the first microwave signal and the second microwave signal in real time; and then by comparing the current phase difference with the preset phase difference by using the preset phase difference as a reference to generate the trigger signal when the current phase difference is the same as the preset phase difference, it is possible to guarantee the phase difference between the first microwave signal and the second microwave signal at the current time point to be consistent with, that is, coherent to, the preset phase difference, and thus guarantee coherence of the phases of the generated qubit driving signals in a plurality of paths.

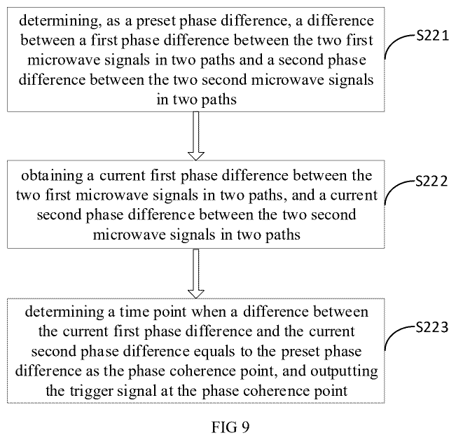

As shown in FIG. 9, as one implementation of an embodiment of the present disclosure, when the secondary frequency conversion technology is adopted to generate the qubit driving signals, said “determining a phase coherence point based on phases of the two microwave signals in two paths and generating a trigger signal according to the phase coherence point” comprises the following steps:
step S221: determining, as a preset phase difference, a difference between a first phase difference between the two first microwave signals in two paths and a second phase difference between the two second microwave signals in two paths;
step S222: obtaining a current first phase difference between the two first microwave signals in two paths, and a current second phase difference between the two second microwave signals in two paths;
step S223: determining a time point when a difference between the current first phase difference and the current second phase difference equals to the preset phase difference as the phase coherence point, and outputting the trigger signal at the phase coherence point.

Specifically, determining the difference between the first phase difference between the two first microwave signals in two paths and the second phase difference between the two second microwave signals in two paths at a certain time point first, and determining the difference value between the first phase difference and the second phase difference as a fixed value, letting the fixed value be a preset phase difference; then measuring at real time the current first phase difference between the first microwave signals and the current second phase difference between the second microwave signals in two paths; and determining the difference value between the current first phase difference and the current second phase difference by calculation and comparing the difference value with the preset phase difference: when the difference value is the same as the preset phase difference, then determine the time point as the phase coherence point. At this time, the phases of the two first microwave signals in two paths are coherent and the phases of the two second microwave signals in two paths are coherent. By outputting the trigger point at the phase coherence point, it is possible to guarantee the coherence of the phases of the generated qubit driving signals in a plurality of paths.

Based on the same inventive concept, an embodiment of the present disclosure provides a quantum computer, comprising the above generation device for qubit driving signals or using the above generation method for qubit driving signals to generate qubit driving signals for adjusting quantum state information of qubits on a quantum chip.

Compared to prior art, the qubit driving signals of the present disclosure is configured for controlling the quantum state information of qubits on a quantum chip, and the qubit driving signals are obtained from processing of intermediate frequency (IF) signals and microwave signals; by outputting a plurality of microwave signals with different frequencies in a plurality of paths first; and then determining the phase coherence point of the first microwave signal and the second microwave signal based on the frequency or phase of the two microwave signals in two paths, wherein the phase coherence point is the time point when the phase difference between the first microwave signals is consistent with that between second microwave signal; and by outputting the trigger signal based on the phase coherence point; by outputting the IF signals corresponding to the qubit driving signals to be generated in response to the trigger signal, and mixing the IF signal with the first microwave signal and mixing the IF signal with the second microwave signal respectively, the phases of the qubit driving signals in a plurality of paths outputted after processed by frequency mixing are coherent.

The above embodiments shown in accordance with the figures have described the structure, characteristics, and effects of the present disclosure in details. The above embodiments are only preferred embodiments of the present disclosure; however, the present disclosure is not limited to the scope of embodiment as shown in the accompanying drawings. Any modifications made in accordance with the inventive idea of the present disclosure, or equivalent embodiments made by equivalent variations thereof, shall fall within the scope of protection of the present disclosure on the premise that it does not go beyond the spirit covered by the description and accompanying drawings.

1. A generation device for qubit driving signals obtained from processing of intermediate frequency (IF) signals and microwave signals comprising:
a microwave source module, configured for outputting a plurality of microwave signals with different frequencies in a plurality of paths, wherein the frequencies of the microwave signals, correspond to frequencies of the qubit driving signals;
a control module, connected to the microwave source module and configured for determining a phase coherence point based on the frequencies or phases of two of the plurality of microwave signals in two paths and outputting a trigger signal according to the phase coherence point, wherein the phase coherence point is a time point when phase differences of the two microwave signals in the two paths are equal;
a waveform outputting module, connected to the control module and configured for outputting the IF signals corresponding to the qubit driving signals in a plurality of paths in response to the trigger signal; and
a signal processing module, connected to the microwave source module and the waveform outputting module, and configured for outputting the qubit driving signals in a plurality of paths based on the IF signals in a plurality of paths and the microwave signals in a plurality of paths.

2. The device according to claim 1, wherein the microwave source module comprises a first microwave source and a second microwave source, wherein a frequency of a first microwave signal output by the first microwave source is lower than that of a second microwave signal output by the second microwave source.

3. The device according to claim 2, wherein when the control module is configured for determining a phase coherence point based on frequencies of the two microwave signals in two paths and outputting a trigger signal according to the phase coherence point, the control module comprises:
a frequency difference determining unit configured for determining a frequency difference between the two microwave signals in two paths;
a trigger cycle determining unit configured for determining a reciprocal of the frequency difference as a trigger cycle of the phase coherence point; and
a first trigger unit configured for outputting the trigger signal based on the trigger cycle.

4. The device according to claim 3, wherein the first microwave signal and the second microwave signal correspond to different qubit driving signals, respectively, and the frequency difference determining unit is configured for:
determining a frequency difference between the first microwave signal and the second microwave signal.

5. The device according to claim 3, wherein the first microwave signal and the second microwave signal correspond to the same qubit driving signal, and the frequency difference determining unit is configured for:
determining a frequency difference between the two first microwave signals in two paths, wherein the two first microwave signals in two paths correspond to qubit driving signals with different frequencies respectively;
wherein the second microwave source is configured for outputting second microwave signals in two paths based on the frequency difference between the two first microwave signals in two paths, wherein a frequency difference between the two second microwave signals in two paths is an integer multiple of the frequency difference between the two first microwave signals in two paths.

6. (canceled)

7. The device according to claim 3, wherein the first trigger unit is configured for outputting the trigger signal at an integer multiple of the trigger cycle.

8. The device according to claim 2, wherein when the control module is configured for determining a phase coherence point based on phases of the two microwave signals in two paths and outputting a trigger signal according to the phase coherence point, the control module comprises:
a first phase difference determining unit configured for determining phase difference between the first microwave signal and the second microwave signal at the same time point as a preset phase difference;
a first phase measuring unit configured for obtaining a current phase difference between the first microwave signal and the second microwave signal; and
a second trigger unit configured for determining a time point when the current phase difference equals to the preset phase difference as the phase coherence point and outputting the trigger signal at the phase coherence point.

9. The device according to claim 2, wherein when the control module is configured for determining a phase coherence point based on phases of the two microwave signals in two paths and outputting a trigger signal according to the phase coherence point, the control module comprises:
a second phase difference determining unit configured for determining a difference between a first phase difference between the two first microwave signals in two paths and a second phase difference between the two second microwave signals in two paths as a preset phase difference;
a second phase measuring unit configured for obtaining a current first phase difference between the two first microwave signals in two paths, and a current second phase difference between the two second microwave signals in two paths; and
a third trigger unit configured for determining a time point when a difference between the current first phase difference and the current second phase difference equals to the preset phase difference as the phase coherence point, and outputting the trigger signal at the phase coherence point.

10. The device according to claim 1, wherein the waveform outputting module comprises at least two waveform generators, each of which is configured for outputting at least one of the IF signals in response to the trigger signal.

11. The device according to claim 10, wherein the control module is configured to simultaneously sends the trigger signal to each of the waveform generators, respectively.

12. The device according to claim 2, wherein the signal processing module comprises at least two frequency mixing units, each of which is configured for:
outputting the qubit driving signal in one path based on the IF signals in two paths and the first microwave signal in one path; or
outputting the qubit driving signal in one path based on the IF signals in two paths and the second microwave signal in one path.

13. The device according to claim 2, wherein the signal processing module comprises at least two frequency mixing units, each of which is configured for:
outputting the qubit driving signal in one path based on the IF signal in one path, the first microwave signal in one path and the second microwave signal in one path.

14. A generation method for qubit driving signals configured for adjusting quantum state information of qubits on a quantum chip and obtained from processing of IF signals and microwave signals, comprising:
obtaining a plurality of microwave signals with different frequencies in a plurality of paths, wherein frequencies of the microwave signals correspond to frequencies of the qubit driving signals;
determining a phase coherence point based on frequencies or phases of the two microwave signals in two paths and outputting a trigger signal according to the phase coherence point, wherein the phase coherence point is a time point when phase differences of the two microwave signals in the two paths are equal;
generating the IF signals corresponding to the qubit driving signals in a plurality of paths in response to the trigger signal; and
outputting the qubit driving signals in a plurality of paths based on the IF signals in a plurality of paths and the microwave signals in a plurality of paths.

15. The method according to claim 14, wherein said obtaining a plurality of microwave signals with different frequencies in a plurality of paths, comprises:
obtaining plurality of first microwave signals with different frequencies in a plurality of paths and a plurality of second microwave signals with different frequencies in a plurality of paths, wherein a frequency of the first microwave signals is lower than that of the second microwave signals.

16. The method according to claim 15, wherein said determining a phase coherence point based on frequencies or phases of the two microwave signals in two paths and outputting a trigger signal according to the phase coherence point, comprises:
determining a frequency difference between the two microwave signals in two paths;
determining a reciprocal of the frequency difference as a trigger cycle of the phase coherence point; and
generating the trigger signal based on the trigger cycle.

17. The method according to claim 16, wherein when the first microwave signals and the second microwave signals correspond to different qubit driving signals, respectively, said determining a frequency difference between the two microwave signals in two paths, comprises:
determining a frequency difference between the first microwave signals and the second microwave signals.

18. The method according to claim 16, wherein when the first microwave signals and the second microwave signals correspond to the same qubit driving signal, said determining a frequency difference between the two microwave signals in two paths, comprises:
determining a frequency difference between the two first microwave signals in two paths, wherein the two first microwave signals in two paths correspond to the qubit driving signals with different frequencies respectively;
wherein when the first microwave signals and the second microwave signals correspond to the same qubit driving signal, said determining a frequency difference between the two microwave signals in two paths, further comprises:
determining two second microwave signals in two paths based on the frequency difference between the two first microwave signals in two paths, wherein a frequency difference between the two second microwave signals in two paths is an integer multiple of the frequency difference between the two first microwave signals in two paths.

19. (canceled)

20. (canceled)

21. The method according to claim 14, wherein said determining a phase coherence point based on phases of the two microwave signals in two paths and generating a trigger signal according to the phase coherence point, comprises:
determining a phase difference between the first microwave signal and the second microwave signal at the same time point as a preset phase difference;
obtaining a current phase difference between the first microwave signal and the second microwave signal;
determining a time point when the current phase difference equals to the preset phase difference as the phase coherence point and outputting the trigger signal at the phase coherence point.

22. The method according to claim 14, wherein said “determining a phase coherence point based on phases of the two microwave signals in two paths and generating a trigger signal according to the phase coherence point”, comprises:
determining a difference between a first phase difference between the two first microwave signals in two paths and a second phase difference between the two second microwave signals in two paths as a preset phase difference;
obtaining a current first phase difference between the two first microwave signals in two paths, and a current second phase difference between the two second microwave signals in two paths;
determining a time point when a difference between the current first phase difference and the current second phase difference equals to the preset phase difference as the phase coherence point, and outputting the trigger signal at the phase coherence point.

23. A quantum computer, comprising a generation device for qubit driving signals according to claim 1, or
configured to use a generation method for qubit driving signals according to claim 14 to generate qubit driving signals for adjusting quantum state information of qubits on a quantum chip.
